(19) United States
(12) Patent Application Publication
(10) Pub. No.: US 2019/0276151 A1
(43) Pub. Date: Sep. 12, 2019

(54) A PASSENGER SEATING ARRANGEMENT WITH A STOWABLE ARMREST

(71) Applicant: ACUMEN DESIGN ASSOCIATES LIMITED, London (GB)

(72) Inventor: Ian Hamilton DRYBURGH, London (GB)

(73) Assignee: ACUMEN DESIGN ASSOCIATES LIMITED, London (GB)

(21) Appl. No.: 16/345,027

(22) PCT Filed: Oct. 26, 2017
(86) PCT No.: PCT/GB2017/053233

§ 371 Date: Apr. 25, 2019

(30) Foreign Application Priority Data
Oct. 28, 2016 (GB) 1618273.5

(51) Int. Cl. B64D 11/06

(52) U.S. Cl. CPC B64D 11/0602; B64D 11/0601; B64D 11/0644; B64D 11/0606; B64D 11/0641

(57) ABSTRACT

A passenger seating arrangement in an aircraft cabin, the passenger seating arrangement including a column of seat units (C1) adjacent an aisle. The column (C1) includes a multiplicity of seat units, each consecutive seat unit alternates between: an inwardly-facing seat unit angled at an acute angle to the longitudinal axis of the aircraft cabin; an outwardly-facing seat unit angled at the same acute angle to the longitudinal axis of the aircraft cabin but facing outwardly away from the aisle. Each seat unit comprises a foot-receiving end. The foot-receiving end of each inwardly-facing seat unit houses a retractable armrest which is configurable between a stowed position, and a deployed position in which the armrest extends to one side away from the foot-receiving end, such that the armrest provides an armrest surface for use by a passenger in the adjacent outwardly-facing seat unit.

### TECHNICAL FIELD

The present invention concerns a passenger seating arrangement for an aircraft and more particularly, a passenger seating arrangement with a stowable armrest.

### BACKGROUND OF THE INVENTION

In a premium (business class or first class) aircraft passenger seating arrangement it is necessary to balance the desire to optimise the passenger experience with the desire not to compromise the packing efficiency of the seating units within the cabin. Certain furniture for example amenity furniture such as tables and armrests, whilst desirable, can be particularly space-consuming within a premium seating layout.

Moveable tables are well known in passenger seating, and it is well known to provide a seat unit with a movable table that can be stowed and deployed for use as required. An example table is shown in WO2013142183 (BE Aerospace) which discloses a passenger suite with a cantilevered table top. The table top is configured to move between a distal position forward of the seat and an over-seat position by means of a linear slide mounted on a side wall. The table top is also configured to pivot to a vertical position and to move from that vertical position along a vertical guide rail, to a retracted position for stowing.

Armrests tend to be fixed to the seat unit, for example GB2326824, or U.S. Pat. No. 7,178,871 (British Airways). There are limited examples of movable armrests. For example, WO200054104 (Newberry et al) discloses an arrangement in which an armrest is rotated down from a vertical to a horizontal position, and US2016/0272323 (Zodiac) discloses an arrangement in which an armrest slides up/down from/into a retracted position in which it is aligned with a bed surface.

There remains a desire for improved passenger amenities, especially armrests, whilst not compromising space-efficiency in an aircraft cabin.

### SUMMARY OF THE INVENTION

According to a first aspect of the invention there is provided a passenger seating arrangement in an aircraft cabin, the passenger seating arrangement comprising a column of seat units adjacent an aisle, and the column of seat units and the aisle both extending in a longitudinal direction parallel to the longitudinal axis of the aircraft cabin, the column comprising a multiplicity of seat units, the seat units being arranged consecutively along the longitudinal direction. Each consecutive seat unit alternates between: an inwardly-facing seat unit angled at an acute angle to the longitudinal axis of the aircraft cabin and facing inwardly towards the aisle; and an outwardly-facing seat unit angled at the same acute angle to the longitudinal axis of the aircraft cabin but facing outwardly away from the aisle. Each seat unit is configurable between a seating configuration and a flat-bed configuration, and each seat unit comprises a foot-receiving end, the foot-receiving end defined by a fixed structure, and wherein the foot-receiving end of each inwardly-facing seat unit houses a retractable amenity surface (preferably a retractable armrest) which is configurable between (i) a stowed position in which the amenity surface is substantially within the footprint of the foot-receiving end and (ii) a deployed position in which the amenity surface extends to one side away from the foot-receiving end, towards an adjacent outwardly-facing seat unit, such that the amenity surface is for use by a passenger in the adjacent outwardly-facing seat unit.

The amenity surface is may be a table. The amenity surface is more preferably an armrest. In the deployed position, the armrest preferably provides an armrest surface for use by a passenger in the adjacent outwardly-facing seat unit. Features below are described with reference to the armrest, but may be equally applicable to embodiments in which the armrest is another amenity surface.

Embodiments of the invention exploit the fact that in an alternating herringbone seating arrangement the foot-receiving end of the inwardly-facing seat unit is adjacent the outwardly-facing seat unit. The present invention recognises that it can therefore be used to provide an armrest for use by a passenger in the outwardly-facing seat unit. Embodiments of the invention also recognise that the foot-receiving end is typically suitable for housing an armrest within its footprint (i.e. it can be have a sufficiency large footprint). Thus an armrest can be stowed in the foot-receiving end when not required, and optionally deployed for use as desired. The foot-receiving end is utilised in a new way, to provide additional amenities for a passenger in the adjacent seat unit, thus improving the passenger experience whilst not compromising packing efficiency in a premium class lay-out. The present invention also recognises that secondary furniture of one seat unit may be used in such a way so as to provide amenities to a passenger in a different, adjacent, seat unit.

Each seat unit is positioned at an acute angle with respect to the longitudinal axis of the aircraft cabin. In other words, the inwardly and outwardly-facing seat units are arranged in an alternately-facing herringbone arrangement. The acute angle at which the inwardly-facing seat unit is orientated with respect to the longitudinal axis of the aircraft cabin, is preferably of substantially identical magnitude to the acute angle at which the outwardly-facing seat unit is orientated with respect to the longitudinal axis of the aircraft cabin. The seats units are thus preferably aligned in parallel (with each other) along the column. The exact value of the acute angle of the seats relative to the longitudinal axis of the aircraft may depend on the size of the aircraft cabin in question. However, the present invention has recognised certain beneficial ranges of acute angle. The acute angle may be at least 30 degrees or more, and more preferably the acute angle is at least 34 degrees or more. The acute angle may be at least 45 degrees or more. The acute angle may be up to 50 degrees. The acute angle may be in the range of 34 to 50 degrees.

A re-configurable seat unit per se is well known in aircraft seating, especially in premium class seating. Such a seat unit may sometimes be referred to as a “lie-flat seat” and that aspect per se is not discussed herein in further detail.

The foot-receiving end is preferably configured to receive a passenger's feet when the seat unit is in the flat-bed configuration. The foot-receiving end may comprise an end wall extending along at least part of a perimeter of the foot-receiving end. The end wall may define a partially enclosed space for receiving a passenger's feet when the seat unit is in the flat-bed configuration.

In some embodiments of the invention, the foot-receiving end may comprise an ancillary bed surface. The ancillary bed surface may be coplanar with the sleeping surface when the seat unit is in the flat-bed configuration, such that the ancillary bed surface acts as a bed-extension surface. The ancillary bed surface may be fixed. The ancillary bed surface may be suitable as a foot rest when the seat unit is in a seating configuration. For example, the foot-receiving end may comprise an ottoman.

In other embodiments the foot-receiving end may not have any ancillary bed surface. For example, it may merely receive a surface (for example one of the moveable seating surfaces) that forms part of the main body and extends into the foot-receiving end when the seat unit is in the flat-bed configuration.

The foot-receiving end may comprise an upper table surface. The upper table surface may be located at a height greater than the height of the flat sleeping surface when the seat unit is in the flat-bed configuration. The upper table surface may be for use by the passenger in the adjacent seat unit. Such an arrangement has been found to provide an especially efficient use of space as the foot-receiving end can effectively provide a functional benefit to two seat units (i.e. to receive a passenger's feet in one seat unit, and to provide a table surface for a different passenger in the adjacent seat unit). The foot-receiving end may comprise a divider shielding and/or preventing access, to the upper table surface from/by a passenger of that seat unit. Such an arrangement provides a clear delimitation of space between the passengers of the seat units. An in-flight entertainment (IFE) display may be associated with the divider.

The foot-receiving end of each outwardly-facing seat unit may border the aisle.

The retractable armrest is preferably fully retractable. The armrest may be configurable for movement to a partially deployed position in which part of the armrest is within the footprint of the foot-receiving end.

Each of the features described in relation to the inwardly-facing seat unit may equally apply to one or more of the outwardly-facing seat units. For example, the foot-receiving end of each outwardly-facing seat unit may house a retractable armrest, the retractable armrest being configurable between (i) a stowed position in which the armrest is substantially within the footprint of the foot-receiving end and (ii) a deployed position in which the armrest extends to one side away from the foot-receiving end, towards an adjacent inwardly-facing seat unit, such that the armrest provides am armrest surface for use by a passenger in the adjacent inwardly-facing seat unit. It will be appreciated that features described herein to the armrest of one of the inwardly or outwardly-facing seat units may be equally applicable to the other of the inwardly or outwardly-facing seat units in the arrangement. It will also be appreciated that ‘extending to one side away from the foot-receiving end’ refers to the armrest being deployed either to the left of, or to the right of the foot-receiving end, when viewed in plan-view.

An arrangement in which the foot-receiving end of each inwardly and each outwardly-facing seat unit houses a retractable armrest may be particularly useful in a ‘twin-aisle’ arrangement, in which there may be a requirement for access to the seats in the column from more than one aisle.

Even in ‘single-aisle’ arrangements in which there may be less need to have a retractable armrest for use by passengers in the inwardly-facing seat units (see comments below regarding the use of the access path), such an arrangement may be beneficial as it may ensure an equal ‘passenger offer’ (i.e. the same passenger experience) which may provide advantages with respect to marketing/pricing. Nevertheless, in some embodiments, the inwardly-facing seat units may be provided with a fixed armrest in the place of the retractable armrest. Such an arrangement may recognise that in a ‘single-aisle’ arrangement in which the column of seats may be required to be accessed from only one side of the column, there may be less or no requirement for a retractable armrest in the foot-receiving end of each outwardly-facing seat unit, for example in cases in which the foot-receiving end of each outwardly-facing seat unit borders a side-wall of the aircraft cabin.

Each seat unit may comprise a seat body. The seat body may comprise moveable seating elements arranged such that when the seat unit is in the seating configuration the seating elements form a passenger seat but when the seat unit is in the flat-bed configuration, the seating elements form a substantially flat sleeping surface.

The moveable seating elements may, for example, comprise a seat pan, a seat back, and/or a footrest. In some embodiments, the moveable seating elements may form substantially all of the sleeping surface when the seat unit is in the flat-bed configuration. In other embodiments, the moveable elements need not necessarily form all of the sleeping surface when the seat unit is in the flat-bed configuration. For example, in some embodiments of the invention, each seat unit may comprises an ancillary bed surface. In the flat bed configuration, the ancillary bed surface may form part of the sleeping surface in conjunction with the moveable seating elements. The ancillary bed surface may be fixed. The ancillary bed surface may be removable (for example it may be created by an insert element). The ancillary bed surface may be at a height such that it is co-planar with the flat sleeping surface formed by seating elements when the seat unit is in the flat-bed configuration. The ancillary bed surface may form an extension of the flat sleeping surface formed by seating elements when the seat unit is in the flat-bed configuration. A seat unit may comprise such an ancillary bed surface at a foot-receiving end of the seat unit. Alternatively or additionally, the seat unit may comprise such an ancillary bed surface at a head-receiving end of the seat unit.

Each seat unit may comprise a central axis. The central axis preferably extends through the centre of the seat (for example it may bisect a seat pan and/or back-rest of the seat when in the seating configuration). The central axis of each seat unit is preferably fixed (for example the seat units preferably do not comprise swivel seats). The angle of the seat unit is preferably defined as the angle between the central axis and the longitudinal axis of the aircraft cabin.

In some embodiments of the invention, both the inwardly-facing seat units and the outwardly-facing seat units may have any or all of the above-mentioned features. However, in other embodiments of the invention, the inwardly-facing seat units may have different features and/or differently shaped features, to the outwardly-facing seat units.

The outwardly-facing seat units may be facing one of forwards or backwards. The inwardly-facing seat units may be facing the other of forwards or backwards. It will be appreciated that the inward/outward facing of the seat unit refers to the orientation relative to the aisle (i.e. whether the passenger would be facing towards or away from the aisle). In contrast, the forward/backward facing of the seat unit refers to the orientation relative to the direction of travel of the aircraft (i.e. whether the passenger would be facing towards the front of the aircraft or towards the rear of the aircraft).

In the deployed position, each armrest may extend towards the seat body of the adjacent seat unit. Such an arrangement may ensure that the armrest is easily reachable by a passenger sitting in the adjacent seat unit in the seating configuration.

Each seat unit may be accessible from the aisle by an access path. The access path may be such that a passenger can pass from the aisle, through the access path, to access the seat unit. The access path to each outwardly-facing seat unit may be located between the seat body of that seat unit and the foot-receiving end of the adjacent inwardly-facing seat unit.

In the deployed position, the armrest of the foot-receiving end of each inwardly-facing seat unit may extend over the access path to the adjacent outwardly-facing seat unit. The armrest may extend over most or all, of the access path to the adjacent outwardly-facing seat unit, such that it is no longer useable as an access path when the armrest is deployed. Embodiments of the present invention recognise that in an acute angle seating arrangement with alternately inwardly and outwardly-facing seat units (i.e. an alternately facing herringbone arrangement), the space apportioned for an access path to the outwardly-facing seat unit, may not be needed specifically for access when the passenger is sitting in the seat. The access path may therefore be a convenient space within reach of a passenger sitting in the outwardly-facing seat, into which an armrest may be deployed. Such an arrangement may advantageously reduce redundant space in the aircraft cabin.

In an arrangement in which the foot-receiving end of each outwardly-facing seat unit also houses a retractable armrest, that armrest may extend over, at least partially, the access path to the adjacent inwardly-facing seat unit in the deployed position. Such a feature may be especially beneficial in a ‘twin-aisle’ arrangement.

The armrest may be configured to move between the stowed and deployed positions within a single plane.

The armrest may be substantially planar (for example it may define a substantially planar upper surface). There may be only a single plane which defines the plane of movement and the plane of the armrest when it is deployed. The plane of movement may be substantially parallel to the floor of the cabin. The plane of movement may be substantially parallel to the plane of the seat unit in the flat-bed configuration. The plane of movement may be substantially horizontal in an absolute frame of reference. The plane of movement may be substantially parallel to the seat pan.

The planar movement of the armrest may be realized in a number of ways. In some embodiments, the armrest may be configured to move by rotation about an axis. The axis of rotation may be substantially vertical.

The armrest may be configured to be operable between the stowed and deployed positions by a passenger sitting in the adjacent seat unit. The armrest may be configured to be deployed via rotation about an axle (i.e. to pivot). The axis of the pivot may be perpendicular to the plane of movement and/or the plane of the armrest when deployed. The axis of the pivot may be located within the footprint of the foot-receiving end. Such a pivoting mechanism may be simple for a passenger to operate, when sitting or lying in the seat. The armrest may comprise a handle and/or a cord and/or a button to initiate its release. The armrest may alternatively or additionally be deployed via another mechanism.

The armrest may be biased towards the stowed position. The armrest may comprise a locking member for holding the armrest in the deployed position such that when the locking member is released, the armrest moves from the deployed position to the stowed position under a biasing force. Such an arrangement may provide a useful safety feature, should the passenger need to quickly exit the seat. Such a feature may also or alternatively enable the armrest to be used by passengers having impaired mobility.

In the deployed position the armrest may be positioned primarily to one side of the seat body of the adjacent seat unit. The armrest may be arranged not to, for example, be deployed in front of the seat body.

In the deployed position the armrest may be located alongside the seat body of the adjacent seat unit. In the deployed position, the armrest may partially overlap the footprint of the seat body of the adjacent seat unit in the seating configuration. Such overlap may be along one side of the seat body. The partial overlap may be small compared to the footprint of the seat unit, for example less than 10%, or even 5% in the seating configuration.

Each inwardly-facing seat unit may be substantially identical to each outwardly-facing seat unit. Thus, the column may be formed from a repeating pattern of (alternately oriented) identical seat units. Each pair of seat units (formed of one inwardly and its adjacent outwardly-facing seat unit) may be identical. The pairs of seat units may be adjacent one another along the longitudinal direction. Within each column, the pairs of seat units may be arranged in the same orientation.

According to a second aspect of the invention, there is provided a pair of seat units for use in the seating arrangement described herein. The pair of seat units is suitable for being arranged adjacent to another identical pair of seat units along a longitudinal direction parallel to the longitudinal axis of the aircraft cabin. Each pair of seat units comprises: an inwardly-facing seat unit angled at an acute angle to the longitudinal axis of the aircraft and facing inwardly towards an aisle; and an outwardly-facing seat unit angled at the acute angle to the longitudinal axis of the aircraft but facing outwardly away from the aisle; wherein, each seat unit is configurable between a seating configuration and a flat-bed configuration, and each seat unit comprises a foot-receiving end, the foot-receiving end defined by a fixed structure, and wherein the foot-receiving end of each inwardly-facing seat unit houses a retractable armrest which is configurable between (i) a stowed position in which the armrest is substantially within the footprint of the foot-receiving end and (ii) a deployed position in which the armrest extends to one side away from the foot-receiving end, towards the adjacent outwardly-facing seat unit, such that the armrest may provide a surface for use by a passenger in the adjacent outwardly-facing seat unit.

According to a third aspect of the invention, there is provided a seat unit for use in the seating arrangement described herein. The seat unit is suitable for being arranged at an acute angle to the longitudinal axis of the aircraft facing inwardly and adjacent a second oppositely orientated seat unit (i.e. outwardly facing) along a longitudinal direction parallel to the longitudinal axis of the aircraft cabin. The seat unit is configurable between a seating configuration and a flat-bed configuration, and the seat unit comprises a foot-receiving end, the foot-receiving end defined by a fixed structure. The foot-receiving end of the inwardly-facing seat unit houses a retractable armrest which is configurable between (i) a stowed position in which the armrest is substantially within the footprint of the foot-receiving end and (ii) a deployed position in which the armrest extends to one side away from the foot-receiving end, towards the adjacent outwardly-facing seat unit, such that the armrest may provide a surface for use by a passenger in the adjacent outwardly-facing seat unit.

According to a further aspect of the invention, there is provided a foot-receiving end of a seat unit for use in the seat units described herein. The foot-receiving end may be defined by a fixed structure, and the foot-receiving end may house a retractable armrest which is configurable between (i) a stowed position in which the armrest is substantially within the footprint of the foot-receiving end and (ii) a deployed position in which the armrest extends to one side away from the foot-receiving end, such that, when installed in an aircraft cabin, the armrest extends towards the adjacent seat unit (which is preferably facing in the opposite direction to the seat unit having said foot-receiving end), such that the armrest may provide a surface for use by a passenger in the adjacent seat unit.

It will of course be appreciated that features described in relation to one aspect of the present invention may be incorporated into other aspects of the present invention. Any of the features described in relation to the armrest may equally apply in the case that the armrest is another amenity surface, for example a table.

### DESCRIPTION OF THE DRAWINGS

An embodiment of the present invention will now be described by way of example only with reference to the accompanying drawings:

FIG. 1 is a plan view of a passenger seating arrangement according to the example embodiment of the invention;

FIG. 2 is a perspective view of the passenger seating arrangement of FIG. 1, with armrests stowed;

FIG. 3 is a perspective view of the passenger seating arrangement of FIG. 1, with two armrests deployed;

FIG. 4 is a perspective view of the passenger seating arrangement of FIG. 1, with armrests stowed and seat units in the flat-bed configuration;

FIG. 5 is a perspective view of an outwardly-facing seat unit of the passenger seating arrangement of FIG. 1 in an aircraft cabin, with armrest deployed;

FIG. 6 is a perspective view of an inwardly-facing seat unit of the passenger seating arrangement of FIG. 1, with armrest deployed;

FIG. 7 is a plan view showing the passenger seating arrangement of FIGS. 1 to 6 within the business-class cabin of a single-aisle aircraft.

### DETAILED DESCRIPTION

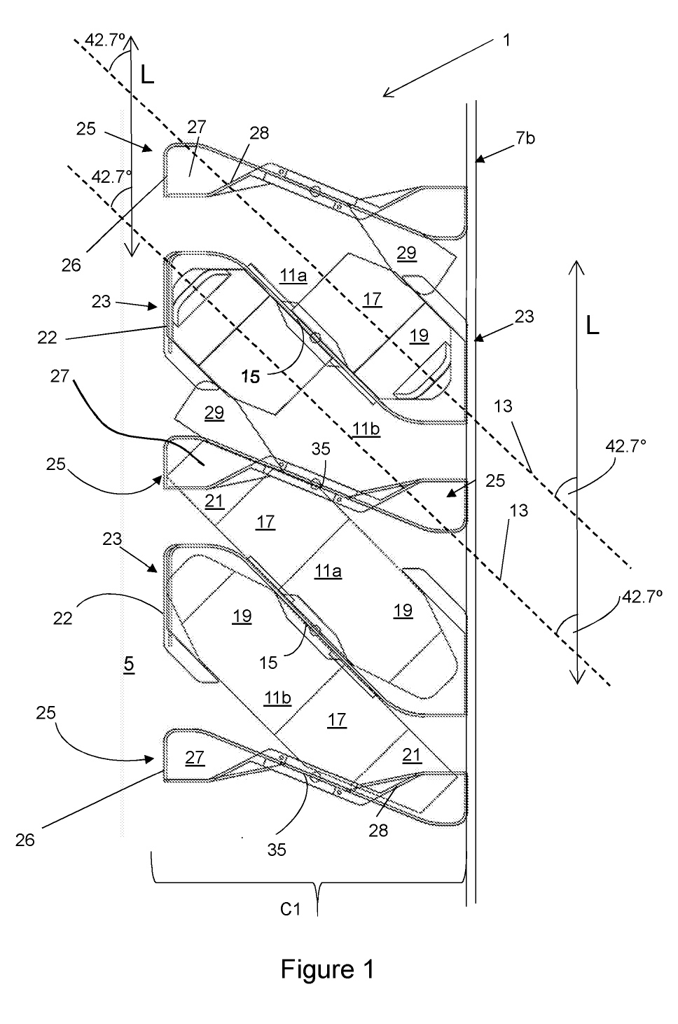

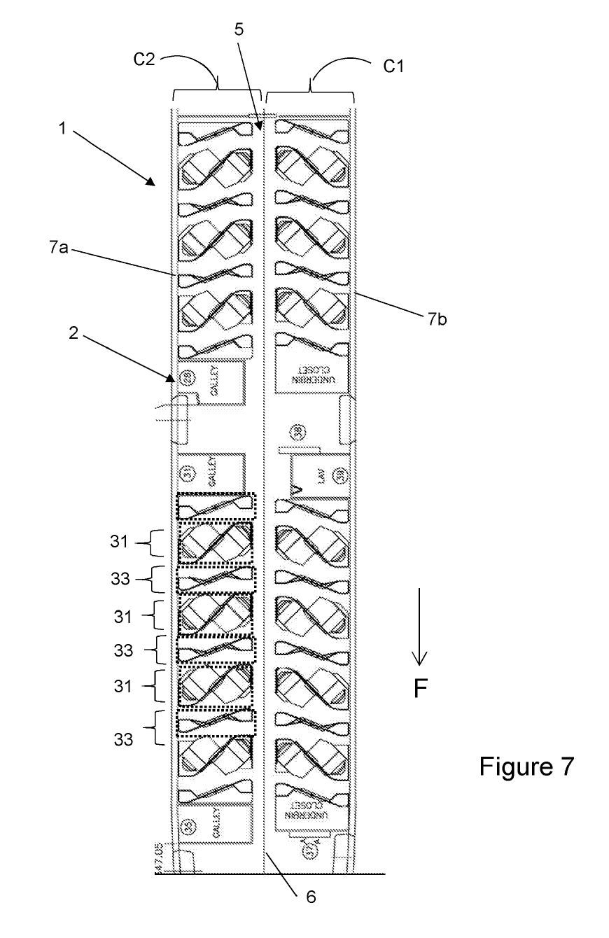

FIG. 1 is a schematic plan view of part of a passenger seating arrangement 1 according to an embodiment of the invention. The passenger seating arrangement 1 is within the business class section of an aircraft cabin 2 (shown in FIG. 7).

The passenger seating arrangement 1 comprises a column C1 of seat units. As shown in FIG. 7, the column C1 is positioned in the aircraft cabin adjacent a second column of seat units C2. The columns C1 and C2 are separated by a central aisle 5 aligned with the longitudinal axis 6 of the cabin. As is most clearly indicated in FIG. 7, the columns C1, C2 of seat units and the aisle 5 all extend in a longitudinal direction parallel to the longitudinal axis 6 of the cabin 2. The aircraft cabin is defined by sidewalls 7a, 7b. The cabin 2 comprises several non-seating areas, such as galleys and lavatories, but these are largely conventional and are not described further herein.

Referring back to FIG. 1, column C1 comprises seat units 11a, 11b, which are substantially identical except for their orientation/position. The seat units 11a, 11b, are arranged adjacent to one another along the longitudinal direction (i.e. neighbouring seat units 11a, 11b are located along the length of each column C1, C2) and alternate in orientation between an inwardly-facing seat unit 11a (facing inwardly towards the aisle) and an outwardly-facing seat unit 11b (facing outwardly away from the aisle 5).

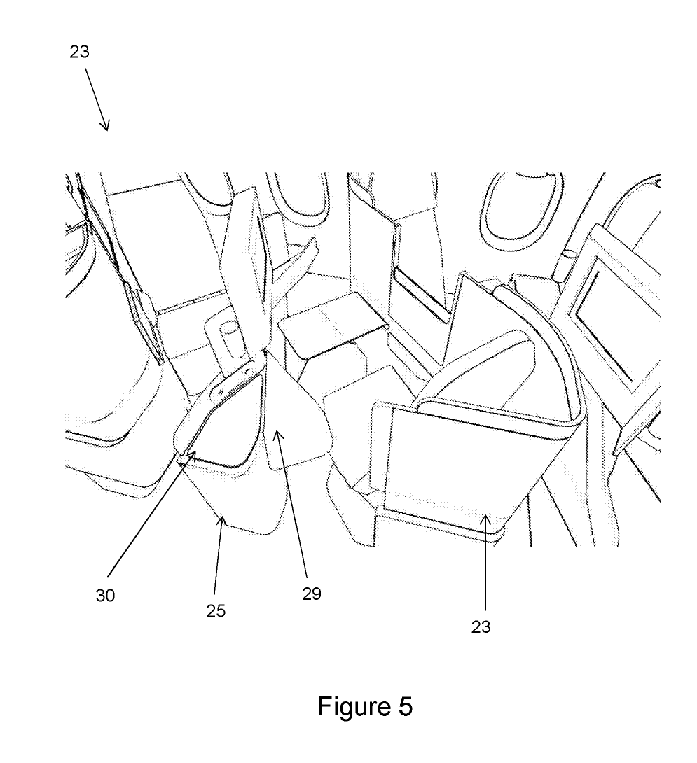

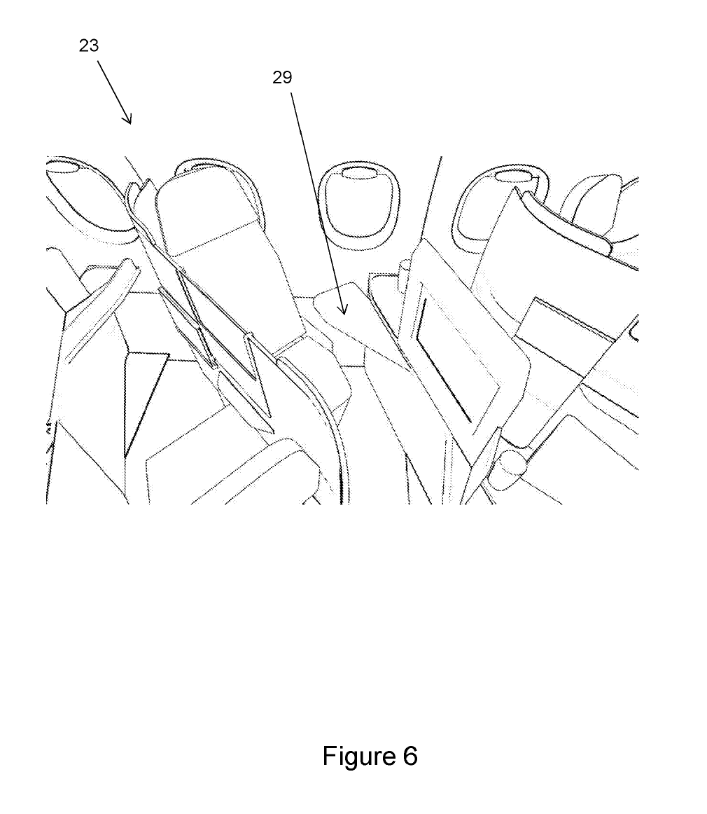

In the description below, where reference is made to only one seat unit (i.e. one of 11a or 11b), it will be appreciated that the description applies equally to the other corresponding seat units 11a, 11b in the seating arrangement 1. Also, for the sake of clarity, not all reference numerals used in certain of FIGS. 1-7 are necessarily repeated in the other of the Figures. The seat units shown in FIGS. 1-7 but not labelled, do of course have the same features.

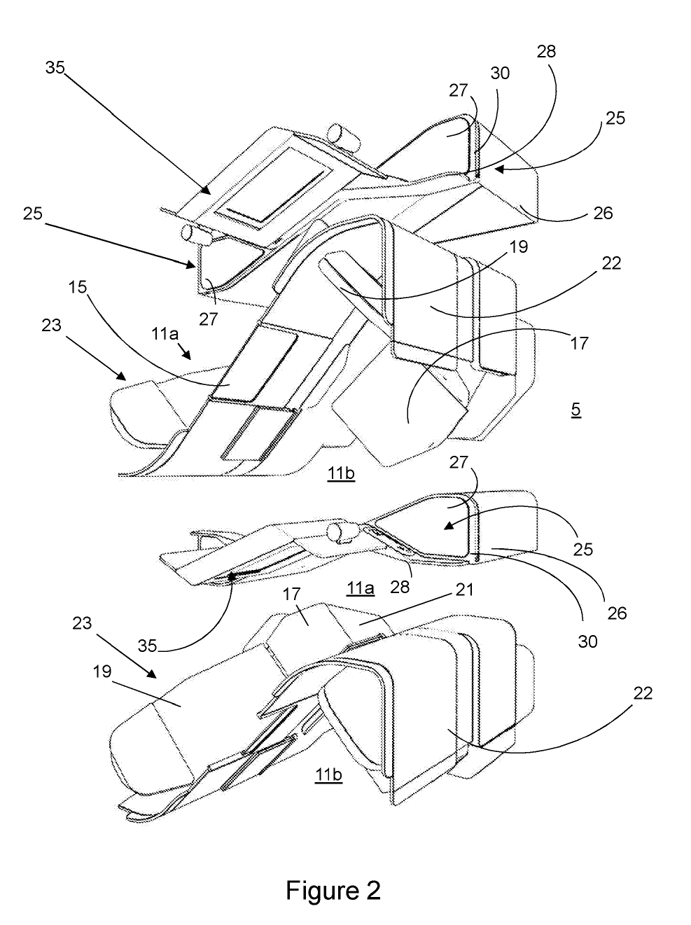

FIGS. 2 to 4 each show an inwardly-facing seat unit 11a and an outwardly-facing seat unit 11b, which together form a pair 9 of seat units. The inwardly-facing seat unit 11a is angled at 42.7 degrees to the longitudinal direction L (which is parallel to the longitudinal axis 6 of the cabin) and faces inwardly towards the aisle 5. The outwardly-facing seat unit 11b is angled at the same angle (42.7 degrees) to the longitudinal direction but faces outwardly away from the aisle 5.

The angle of the seat unit to the longitudinal direction is measured by the angle that the central seat unit axis 13 makes with the longitudinal direction L (and the aisle axis 6). The central axis of a seat unit is the axis that bisects the seat body of the respective seat unit 11a/11b.

The inwardly-facing seat unit 11a faces backwards (relative to the direction of flight F (see FIG. 7)), whereas the outwardly-facing seat unit faces forwards (relative to the direction of flight F).

The inwardly-facing seat unit 11a and outwardly-facing seat unit 11b in each pair 9 of seat units, border each other along an intra-pair privacy screen 15 that defines a shared boundary (see FIG. 1). That boundary runs parallel to the central axis 13 of the seat units (i.e. at 42.7 degrees to the longitudinal direction). The privacy screen 15 is selectively retractable such that it can be raised or lowered depending on whether passengers in the seat units wish to interact with each other.

Each seat unit 11a, 11b comprises a main body 23 and a foot-receiving end 25. The main body 23 has a moveable seat pan 17, movable back rest 19 and moveable leg support 21. A shroud 22 surrounds the back rest 19. The foot receiving end 25 is spaced apart from the main body 23 and is in the form of a curved end wall 26 extending from the cabin floor having an upper table surface 27. The foot receiving end does not comprise an ottoman. Instead, the end wall 26 defines a partially enclosed space into which the passenger may insert their feet when the seat unit is in the flat-bed configuration. A low divider 28 shields the table surface 27 from the passenger in that seat unit 11a, 11b, but the table surface 27 is instead accessible to the passenger in the adjacent seat unit, thereby providing a convenient surface to one side of their seat unit.

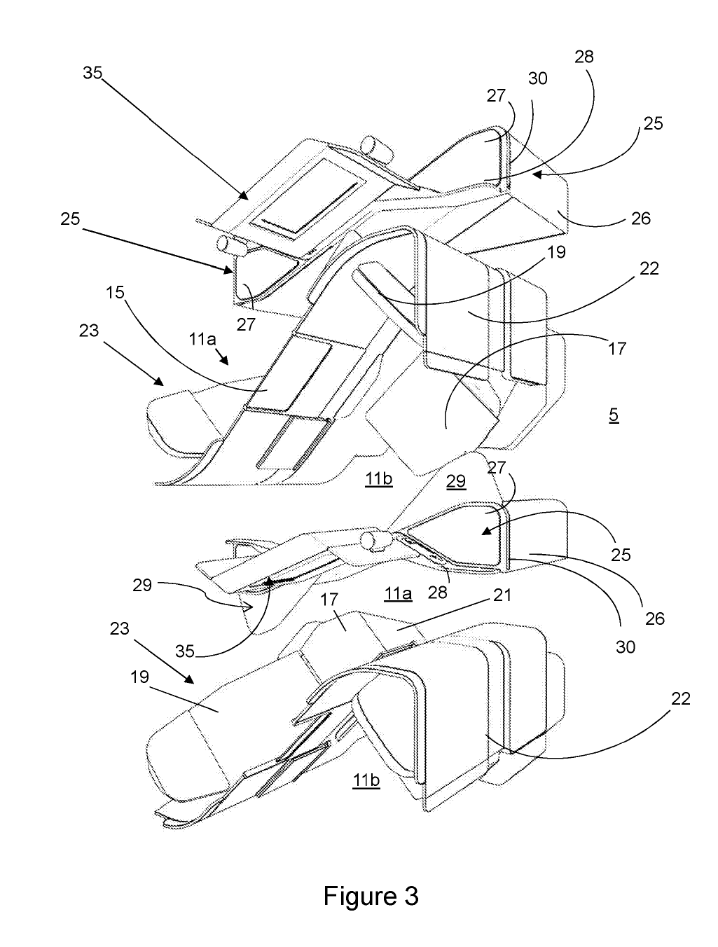

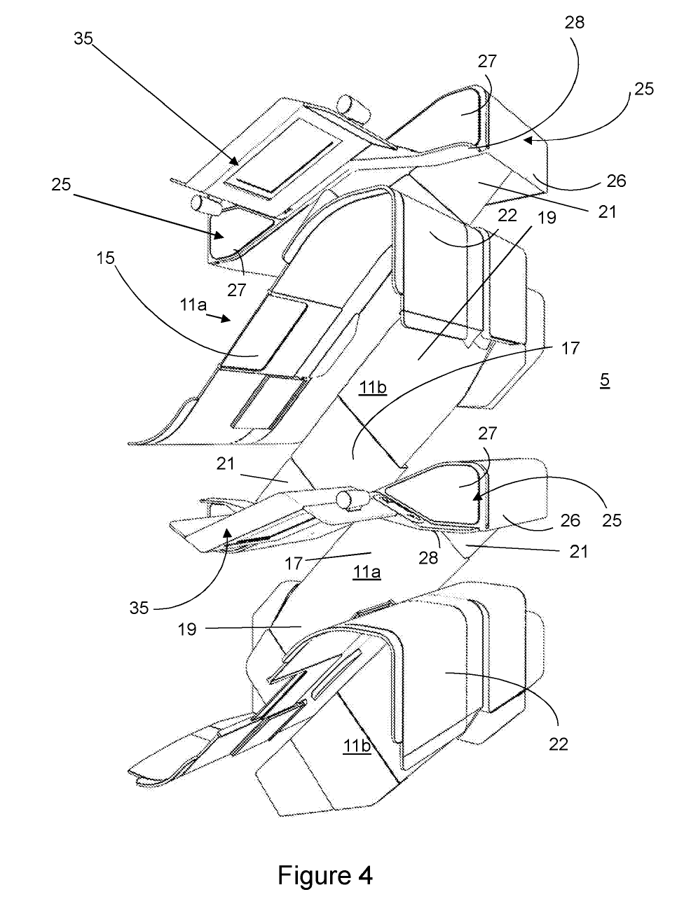

Each seat unit 11a, 11b is configurable between a seating configuration and a flat-bed configuration. In the seating configuration (shown in FIGS. 2 and 3) the moveable elements 17, 19, 21 of the main body 23 form an upright passenger seat with the foot-receiving end 25 located in front of the seat. The moveable seat pan 17, movable back rest 19 and moveable leg support 21 may, however, be configured into a 75-inch-long flat sleeping surface (shown in FIG. 4) such that the seat unit is in a flat-bed configuration. In that flat-bed configuration, the moveable elements are all coplanar and the leg rest 21 extends into the space enclosed by the wall 26 of the foot receiving end 25. The use of moveable seat elements and conversion between a seating configuration and a lie-flat configuration is known per se and will not be described in further detail herein. The benefits enabled by embodiments of the present invention tend to instead reside in other aspects of the seat units, and their layout, as will now be described in more detail.

In the embodiment described, the seating arrangement 1 is provided in a single-aisle aircraft. Each column C1, C2 borders the aisle 5 on one (inner) side and the aircraft sidewall on the other (outer) side. Providing columns C1, C2 of seat units having alternately facing inward and outward seats units 11a, 11b (relative to the aisle) has been found to be an especially space-efficient way of providing passenger seating on a single-aisle aircraft, without compromising passenger access to each seat unit.

As is most clearly shown in FIG. 7, the respective main bodies 23 of seat units 11a, 11b, are arranged as a series of modules 31 spaced along the length of each column. The foot-receiving end 25 of the inwardly-facing seat unit 11a and the foot-receiving end 25 of the adjacent outwardly-facing seat unit 11b are also arranged as a series of modules 33, alternately located along the longitudinal direction of each column, between the main body modules 31. Providing separate modules for the main bodies 23 of the seat units 11a, 11b and the foot-receiving ends 25 is advantageous because then they can be constructed to different standards with respect to certification. Specifically, since the main body modules 31 contain the passenger when seated, they are therefore certified to 16-g, but the foot-receiving end modules 33 do not house the passenger when seated, and can therefore be certified to a lower g loading (9-g in this case).

The end wall 26 of the foot-receiving end is asymmetrical (about the centre-line of the foot-receiving end). On one side, it smoothly blends into an inter-pair privacy screen 35, which is orientated at angle to the central axis 13 of the seat units 11a, 11b. Such an arrangement has been found to be beneficial as it may enable a relatively wide spacing to be created between the foot-receiving end 25 of one seat unit and the main body 23 of an adjacent seat unit.

The foot-receiving end 25 of each inwardly-facing seat unit 11a (and each outwardly-facing seat unit 11b) includes, just beneath its upper surface, a slot recess 30 extending substantially through the cross-section of the foot-receiving end 25. The recess 30 is closed on the internal side of the foot-receiving end 25 i.e. the side facing the seat body 23 of the seat unit to which the foot-receiving end 25 belongs, and open on the other side i.e. the external side of the foot-receiving end 25 facing the adjacent seat unit.

Housed within the recess is an armrest 29. The armrest 29 is sized and shaped to fit snugly within the slot recess 30. The armrest 29 is broadly triangular, being narrower towards the centre of the seat unit, and wider towards the end of the seat unit. In its stowed position, the armrest 29 fits completely within the recess 30 so that it is contained entirely within the footprint of the foot-receiving end 25. The armrest 29 moves freely about a pivot at its inner corner (i.e. the point most inward of the aisle). The pivot pin is oriented perpendicular to the plane of the armrest 29, so that the armrest 29 moves in a single plane. The plane of the armrest 29 in the embodiment described is parallel to the plane of the seat unit in the flat-bed configuration.

The armrest 29 is prevented from rotating away from the foot-receiving end 25 by means of a lip (not shown), which catches on the upper edge of the slot recess 30 when the armrest 29 is in its fully extended position. The armrest 29 therefore rotates freely to a position of maximum rotation beyond which it does not rotate. That position of maximum rotation is the deployed position.

In the position of maximum rotation (the deployed position) the armrest 29 of each inwardly-facing seat unit extends over the access path from the aisle 5 to the adjacent outwardly-facing seat unit 11b. The armrest 29 overlaps slightly the seat body of the outwardly-facing seat unit 11b. The overlap is small, so that only a small portion of the armrest 29 and seat pan 17 is covered by the armrest 29. Since the seat bodies 23 of the inwardly-facing seat units 11a are adjacent a sidewall of the aircraft, the armrests 29 which extend towards those seats (i.e. from the foot-receiving ends 25 of the adjacent outwardly-facing seat units 11b) do not block any access path, but instead make use of space which would otherwise be redundant.

Whilst the present invention has been described and illustrated with reference to a particular embodiment, it will be appreciated by those of ordinary skill in the art that the invention lends itself to many different variations not specifically illustrated herein. By way of example only, certain possible variations will now be described.

In the present embodiment described, every inwardly-facing seat unit 11a comprises a retractable armrest 29. In an alternative embodiment not described, only some of the inwardly-facing seat units 11a have retractable armrests 29. In the present embodiment described the foot-receiving end 25 of each outwardly-facing seat unit 11b includes an armrest 29. In an alternative embodiment, only some or none of the outwardly-facing seat units comprise armrests 29.

In an embodiment of the invention not described, the foot receiving end may instead comprise a different amenity surface such as a table surface.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1.-14. (canceled)

15. A passenger seating arrangement in an aircraft cabin, the passenger seating arrangement comprising a column of seat units adjacent an aisle, and the column of seat units and the aisle both extending in a longitudinal direction parallel to the longitudinal axis of the aircraft cabin,
the column comprising a multiplicity of seat units, the seat units being arranged consecutively along the longitudinal direction, and wherein each consecutive seat unit alternates between:
an inwardly-facing seat unit angled at an acute angle to the longitudinal axis of the aircraft cabin and facing inwardly towards the aisle;
an outwardly-facing seat unit angled at the same acute angle to the longitudinal axis of the aircraft cabin but facing outwardly away from the aisle; and
each seat unit is configurable between a seating configuration and a flat-bed configuration, and
each seat unit comprises a foot-receiving end, the foot-receiving end defined by a fixed structure, and wherein
the foot-receiving end of each inwardly-facing seat unit houses a retractable armrest which is configurable between (i) a stowed position in which the armrest is substantially within the footprint of the foot-receiving end and (ii) a deployed position in which the armrest extends to one side away from the foot-receiving end, towards an adjacent outwardly-facing seat unit, such that the armrest provides an armrest surface for use by a passenger in the adjacent outwardly-facing seat unit.

16. A passenger seating arrangement according to claim 15, wherein each seat unit comprises a seat body, the seat body comprising moveable seating elements arranged such that when the seat unit is in the seating configuration the seating elements form a passenger seat but when the seat unit is in the flat-bed configuration, the seating elements form a substantially flat sleeping surface.

17. A passenger seating arrangement according to claim 16, wherein in the deployed position, the armrest extends towards the seat body of the adjacent outwardly seat unit.

18. A passenger seating arrangement according to claim 15, wherein each seat unit is accessible from the aisle by respective access path, and wherein in the deployed position, the armrest of the foot-receiving end of each inwardly-facing seat unit extends over the access path to the adjacent outwardly-facing seat unit.

19. A passenger seating arrangement according to claim 15, wherein the armrest is configured to move between the stowed and deployed positions within a single plane.

20. A passenger seating arrangement according to claim 19, wherein each seat unit comprises a seat pan and the armrest is configured to move between the stowed and deployed positions within a plane which is above the seat pan of the adjacent seat unit.

21. A passenger seating arrangement according to claim 15, wherein the armrest is configured to be operable between the stowed and deployed positions by a passenger sitting in the adjacent outwardly-facing seat unit.

22. A passenger seating arrangement according to claim 15, wherein the armrest is biased towards the stowed position.

23. A passenger seating arrangement according to claim 15, wherein the foot-receiving end of each outwardly-facing seat unit also houses a retractable armrest, the retractable armrest being configurable between (i) a stowed position in which the armrest is substantially within the footprint of the foot-receiving end and (ii) a deployed position in which the armrest extends to one side away from the foot-receiving end, towards an adjacent inwardly-facing seat unit, such that the armrest provides an armrest surface for use by a passenger in the adjacent inwardly-facing seat unit.

24. A passenger seating arrangement according to claim 23, wherein each inwardly-facing seat unit is substantially identical to each outwardly-facing seat unit.

25. A pair of seat units for use in the seating arrangement of claim 15, the pair of seat units being suitable for being arranged adjacent to another identical pair of seat units along a longitudinal direction parallel to the longitudinal axis of the aircraft cabin, and the pair comprising:
an inwardly-facing seat unit angled at an acute angle to the longitudinal axis of the aircraft and facing inwardly towards an aisle; and
an outwardly-facing seat unit angled at the acute angle to the longitudinal axis of the aircraft but facing outwardly away from the aisle; wherein
each seat unit is configurable between a seating configuration and a flat-bed configuration, and each seat unit comprises a foot-receiving end, the foot-receiving end defined by a fixed structure, and wherein
the foot-receiving end of each inwardly-facing seat unit houses a retractable armrest which is configurable between (i) a stowed position in which the armrest is substantially within the footprint of the foot-receiving end and (ii) a deployed position in which the armrest extends to one side away from the foot-receiving end, towards the adjacent outwardly-facing seat unit, such that the armrest may provide a surface for use by a passenger in the adjacent outwardly-facing seat unit.

26. A seat unit for use in the seating arrangement of claim 15, the seat unit being suitable for being arranged at an acute angle to the longitudinal axis of the aircraft facing inwardly and adjacent a second oppositely orientated seat unit (i.e. outwardly facing) along a longitudinal direction parallel to the longitudinal axis of the aircraft cabin, wherein the seat unit is configurable between a seating configuration and a flat-bed configuration, and the seat unit comprises a foot-receiving end, the foot-receiving end defined by a fixed structure, and wherein the foot-receiving end of the inwardly-facing seat unit houses a retractable armrest which is configurable between (i) a stowed position in which the armrest is substantially within the footprint of the foot-receiving end and (ii) a deployed position in which the armrest extends to one side away from the foot-receiving end, towards the adjacent outwardly-facing seat unit, such that the armrest may provide a surface for use by a passenger in the adjacent outwardly-facing seat unit.

27. A foot-receiving end of a seat unit for use in the seat unit of claim 15,
the foot-receiving end defined by a fixed structure and the foot-receiving end housing a retractable armrest which is configurable between (i) a stowed position in which the armrest is substantially within the footprint of the foot-receiving end and (ii) a deployed position in which the armrest extends to one side away from the foot-receiving end, such that, when installed in an aircraft cabin, the armrest extends towards the adjacent seat unit (which is preferably facing in the opposite direction to the seat unit having said foot-receiving end), such that the armrest may provide a surface for use by a passenger in the adjacent seat unit.
